(19) United States
(12) Patent Application Publication
(10) Pub. No.: US 2026/0114391 A1
(43) Pub. Date: Apr. 30, 2026

(54) UPGRADEABLE VALVE CONTROLLER

(71) Applicant: Lumo, Inc., Santa Rosa, CA (US)

(72) Inventor: Henry M. Halimi, Los Angeles, CA (US)

(73) Assignee: Lumo, Inc., Santa Rosa, CA (US)

(21) Appl. No.: 19/430,621

(22) Filed: Dec. 23, 2025

Related U.S. Application Data
(63) Continuation-in-part of application No. 19/015,635, filed on Jan. 10, 2025.
Application No. 19/015,635 is a continuation of application No. 18/670,529, filed on May 21, 2024, now Pat. No. 12,193,369.
Application No. 18/670,529 is a continuation of application No. 18/404,894, filed on Jan. 5, 2024, now Pat. No. 12,029,172.
(60) Provisional application No. 63/478,926, filed on Jan. 7, 2023.
(60) Provisional application No. 63/739,066, filed on Dec. 26, 2024.

(51) Int. Cl. A01G 25/16; F16K 7/12; F16K 7/17

(52) U.S. Cl. CPC A01G 25/16; F16K 7/126; F16K 7/17

(57) ABSTRACT

A method of activating additional features within an electronic fluid control device with a first level capability is disclosed. A first level capability has at least one additional feature of the electronic fluid control device disabled. A first request is transmitted from the electronic mobile device to a distant server for a second level capability that enables the additional feature. The server evaluates whether the first request can be granted based upon a server level qualification. A first request response is automatically sent from the distant server to the electronic mobile device either granting or denying the first request. If granted, the first request response includes an activation code enabling the second level capability. A user then manually presses a wake button on the device and the activation code is automatically sent from the electronic mobile device to the electronic fluid control device enabling the additional feature.

### CROSS-REFERENCE TO RELATED APPLICATIONS

This continuation-in-part application claims priority to provisional application 63/739,066 filed on Dec. 26, 2024, the entire contents of which are hereby incorporated in full by this reference.

This application is also a continuation-in-part of application Ser. No. 19/015,635 filed on Jan. 10, 2025; which itself is a continuation of application Ser. No. 18/670,529 filed on May 21, 2024 (now U.S. Pat. No. 12,193,369); which itself is a continuation of application Ser. No. 18/404,894 filed Jan. 5, 2024 (now U.S. Pat. No. 12,029,172); which itself claims priority to provisional application 63/478,926 filed on Jan. 7, 2023, the entire contents of which all applications are hereby incorporated in full by these references.

### DESCRIPTION

### Field of the Invention

The present invention generally relates to water flow control. More particularly, the present invention relates to a water flow control device that is designed to provide increased capabilities with a tiered activation configuration.

### Background of the Invention

U.S. Pat. No. 12,029,172 B1 which is U.S. application Ser. No. 18/404,894 filed on Jan. 5, 2024, U.S. Pat. No. 12,193,369 which is U.S. application Ser. No. 18/670,529 filed on May 21, 2024, and U.S. application Ser. No. 19/015,635 filed on Jan. 10, 2025, which were by the same inventor as the present application, are incorporated herein in full by these references.

U.S. application Ser. No. 14/182,213 filed on Aug. 21, 2014, which is also by the same inventor as the present invention, is also fully incorporated herein with this reference.

Despite recent technological advances with the Internet of Things, where almost all electronic home devices are getting smarter and more capable with wireless connections and associated software, the agricultural field has lagged. For example, it is still common for farmers and/or workers to manually turn-on and off the irrigation valves on a daily or a regular basis to water their crops, such as grapes in vineyards, almonds, berries, citrus, apples, etc. However, many times such farmers or their workers either forget to turn on or forget to turn off these valves according to watering schedules resulting in overwatering or underwatering. Such manual control also requires that the farmer/worker be on site each time such watering is needed and most importantly these operations can only take place during the day. There are many advantages to night watering such as reduced evaporation and cheaper power sources.

In many agricultural settings the fields are divided into blocks that each require different irrigation schedules and watering volumes. In the complex agricultural settings these schedules may be managed by different teams. Water supply to most irrigation systems is provided by pump(s) that provide pressurized water in the irrigation lines. Most larger farms have multiple pumps that either provide water to a specific section of the farm or provide water to a manifold that is on the outlet side of two or more pumps. Depending on the demand from the irrigation schedule, pump(s) are turned on and off and the speed that the pump runs at is also adjusted to provide the desired flow and pressure to all demand points. Manual operation of the pumps and communication of field information to the pump operators to actuate the pumps is expensive and lacks accountability.

Despite the recent global technological advances, the agricultural industry has not kept pace with modernization that other industries have enjoyed. There have been very few fundamental breakthroughs compared to the other industries and the agricultural industry has progressed organically by introduction of many “better and improved ways” that have been incomprehensive fixes to larger existing issues. There have been very few efforts to resolve the root cause. For decades field automations have been in the forefront of the agriculture industry innovations, but most of the systems have failed due to extensive use of wiring to power the irrigation valves and control devices. Additionally, all previous attempts have relied on line power and control devices that have been adopted from other industrial applications, rendering these systems unreliable and hard to use in an agricultural setting. Experience has shown that wiring in the agricultural fields is prone to damage and hard to maintain. This is the reason behind the manual use of most of the automated valves in agricultural applications.

Thus, there have been devised automated agricultural valves that attempt to reduce such problems and lead to a more reliable watering operation. These automated valves for agricultural use are similar to the solenoid valves used for residential landscaping watering but are much larger in diameter. The actuation of these residential valves is by means of applying electric voltage to a solenoid coil that in turn moves a plunger to divert pressurized water between upper and lower chambers of the valve. Due to the high peak and consumption demand of the solenoids these valves are powered by (line voltage) electric power and the valves are hard wired to the control panel. Hard wiring is maintainable in smaller areas such as residential applications but in the farming applications they have proven to be unreliable and damage prone. Hence the electrical actuation is hardly ever used, and the valves are manually operated. This is obviously expensive and labor intensive considering the size of agricultural fields. Furthermore, there is a variation of the solenoids that latch in the on or off position with alternating electrical pulses. These are much lower in power consumption but still have usage peak upon actuation. The reason these valves are not favored in agriculture is the fact that they stay on or off without the user knowing what status they are which leads to a no feedback situation.

Furthermore, most agricultural solenoid valves are equipped with a flow regulator that restricts the valve diaphragm movement. This limits the volume of water that may pass through the valve. Turning this control knob allows the farmer/worker the ability to control the flow volume once the valve is turned on. The flow “control knob” on the agricultural valves that are equipped with this feature are placed on the top of the valve that is very obvious and easily accessible. The flow control feature is normally used once or twice in a growing season and is not intended for everyday use. With unrestricted access, these knobs may be turned and the flow adjusted by good-intentioned but curious individuals or even by unscrupulous people such as vandals or competitive businesses. The prominent position and ease of access to these valves invites tampering. As mentioned above, the current flow control knobs for agricultural valves have a large adjustment knob at the very top of the device. The adjustment knob is an attractive nuisance that may be adjusted by people who come across it not knowing the problems they are creating if they turn these knobs. Adjustments made by untrained, uneducated, or ill-intended actors may result in damage to the crops due to overwatering or underwatering.

Furthermore, rodents, livestock, farm machinery, and the like can negatively impact these automated valves. Rats and mice can chew through the water piping or the electronic wires used to control such automated valves. These conditions can cause havoc as such problems may go unnoticed for days or even weeks. After learning of all the various ways automated waterflow control devices may be impaired, the inventor of the present invention created solutions in the previous applications which reduced and/or eliminated such problems.

However, a valve control assembly requires a considerable level of financial and operational commitment to adopt a fully automated system. A fully automated system may not be attainable by all users at the outset. However, these users may still desire to adopt a fully automated system in the future. Normally, the choice is between no automation and expensive add-on equipment. Some have adopted the off-the-shelf generic valves and thereafter attach aftermarket accessories, but this does not result in an optimal valve control assembly that can be integrated into a fully functional automated system.

Accordingly, there is a need for a device that can grow with the user, unlocking features as the user can afford them while keeping the initial purchase and installation costs low to enable use of a device and associated system. The present invention fulfills these needs and provides other related advantages. This is often the case when a farm has new plants that are not fruit bearing and do not need the level of care that the mature trees do. Hence, one can start with a simple automation solution and upgrade to a more sophisticated approach later.

### SUMMARY OF THE INVENTION

This application teaches a near-field wireless communication and/or a short-range wireless communication capable “valve controller” that facilitates upgrade to valve operational features based on receipt of financial or informational considerations. The function of a valve “control assembly” has been defined in the previously referenced patents. This application now teaches a similar valve controller with novel features and functionality.

Near-field communication (NFC) is an ultra-short-range wireless technology that enables two electronic devices to exchange data when they are within just a few centimeters—typically up to 4 cm (1.5 inches). Operating through magnetic field induction at 13.56 MHz in the worldwide unlicensed ISM band, NFC allows secure, low-speed data transfer. Built on RFID principles, it supports three core modes of operation: card emulation for contactless payments, tag reading for interacting with embedded NFC chips, and peer-to-peer communication for simple device-to-device sharing. NFC's extremely limited range enhances both security and intentionality, making it ideal for mobile payments, access control, and quick device pairing.

Short-range communication extends beyond NFC's very tight proximity requirements, covering distances from roughly 10 to 100 meters. This category includes widely used technologies such as Bluetooth, which offers moderate data rates for audio streaming, peripheral connectivity, and IoT; Wi-Fi, which supports high-speed networking for homes, businesses, and public spaces; Zigbee and Z-Wave, which provide low-power mesh networking ideal for smart home sensors and automation; and Ultra-Wideband (UWB), which provides precise spatial and directional awareness for location tracking. These technologies balance power consumption, range, and throughput to support a diverse ecosystem of personal devices and IoT applications.

Long-range communication technologies cover distances from several kilometers to tens of kilometers, enabling wide-area connectivity across cities, regions, and rural environments. Cellular networks such as 4G and 5G provide mobile broadband, voice, and data services for millions of devices simultaneously. Low-power wide-area network (LPWAN) technologies—including LoRa, NB-IoT, and Sigfox—are designed for IoT devices that require long battery life and infrequent, low-bandwidth transmissions. LoRa can reach 10-40 kilometers in rural areas, while NB-IoT and Sigfox excel in low-power deployments such as environmental monitoring, utility metering, and asset tracking.

Comparing these three categories reveals trade-offs in range, power consumption, speed, and security. NFC excels at secure, intentional interactions due to its extremely short range, making it ideal for payments and access control, but it is unsuitable for sustained data transfer. Short-range systems offer greater versatility, higher data rates, and support for many consumer and IoT applications, though they typically consume more power and have increased exposure to interference or unauthorized access if improperly secured. Long-range communication provides broad coverage and supports large-scale IoT or mobile networks, but often at the cost of higher power requirements, lower throughput (in the case of LPWAN), and increased infrastructure complexity. Together, the three classes of communication technologies provide complementary capabilities across the full spectrum of modern wireless connectivity needs.

This application teaches a valve controller that provides several levels of automation and access to information where the initially installed valve can easily be used to fully automate the system. This valve controller can be powered by electricity, batteries or solar. In the following discussions, the valve controller is referred to as the “U-Device” and the software application that communicates with the U-Device via near-field communication is called “U-App”. The U-Device connects to the valve described in the referenced patents in a similar manner to the “control assembly”. The U-App can be downloaded to an electronic smart device such as a smart phone, a smartwatch, a mobile device, a tablet, a laptop computer, a mobile computer or the like that is equipped with a compatible near-field communication and/or short-range communication such as Bluetooth.

The valve controller device may include a manually activated wake button that wakes up the valve controller device when it is in a sleep mode. This would last for a set period of time, where afterwards the valve controller device goes back into the sleep mode. Alternatively, the Bluetooth connection can stay active if a connection is established and stays active during this connection. Additionally, the device processor may be configured to enter a sleep/low power usage mode and thereafter wakes up when a flow is sensed and/or BT is activated. This is done to limit the amount of energy being consumed by the device.

The U-Device is built with a certain number of built-in features, but not all these features are available when the device is first put in service. Specific “Activation Codes” applied to the U-Device unlock certain features. Each feature has an activation code that unlocks a certain feature on a certain device. Once a feature is unlocked, it will stay unlocked until it is locked, or it has timed out. Depending on the activation code, only certain users or all users can connect and communicate with the device to the U-Device.

In addition to other information, the activation code contains the following information: a U-Device unique ID; the specific feature authorization code that it intends to unlock; and access authorization that allows certain users or all users access the features. Authorization code(s) are obtained from a cloud-based center that collects data or financial considerations in addition to other conditions.

Initially, the device of the present invention has to be registered to unlock the free and paid features. The user may register the device through U-APP by providing various information such as name, farm name, email, phone number, location of name (Block x of farm y) and the like. An account may then be created for that user and the particular device valve is listed under this account. There may be many device valves under the same account. The account is the means for code generation, billing and other matters. If internet is available to the U-APP at the initial connection, the GPS location of the device may also recorded. Cloud data provides a dashboard to the authorized users to see and get notifications on the data.

After registration, amongst other features/actions the U-App conducts the following upon connection to a U-Device: (1) reads the device unique ID Code; (2) uploads any new or updated activation permission code(s); (3) reads the activation status from the device; (4) downloads any data not previously downloaded; (5) uploads any data intended for the U-Device; and (6) depending on the Activation status, the U-App prompts the user to: (6a) if the U-Device is new (no previous authorizations) it requests the solicits and presents new features as previously described, where it additionally, records the requested authorizations and connects to the cloud-based center via internet to obtain authorization, which may take place in real time of off-line; and/or (6b) if initial authorization has been done, suggests advancing to higher authorization(s). The data downloaded to the cloud from a U-Device can be accessed by authorized user(s). Additionally, data intended for a U-Device is uploaded to an authorized smart device to be uploaded to a U-Device when connected.

All U-Devices are initially manufactured with full features and related hardware built in. However, all features (except manual on/off) could be restricted. Each U-Devices has a unique ID that is either scannable or can be retrieved from the U-Device when connected to a smart device. The U-App can communicate with U-Devices via Bluetooth or other wired or wireless means.

The U-App is capable of reading the U-Device unique ID code. The U-App can use a unique Activation Code to unlock a specific feature on a specific U-Device. The Activation Codes are obtained (via the internet) after meeting the requirements that includes: owner, installation location, agreements with the applicant's T&Cs, payment (if applicable) and others. Once a feature in a device is unlocked, it may stay unlocked, and every Bluetooth enabled user can access that feature on the U-Device.

Depending on the features, the two-way communication between the U-App and the U-Device also enables data exchange, OTA, schedule downloads, and/or U-Device time synchronization.

The U-Device specifications could be designed to be connected to a standard water control valve, operate with batteries (e.g., replaceable batteries), include a microcontroller with Bluetooth and data storage capability, include a flow sensor board that is connected to the microcontroller (microcontroller sleeps when flow is zero and the wake up button on the device has not been actuated), external switches and LEDs for manual operation, and have a manual on/off feature is pre-activated on U-Devices.

Regarding the U-Device application, the U-device becomes visible upon pressing a button. As soon as the U-App connects to the U-Device, the U-App performs the following functions: reads the device unique ID Code; uploads any new Activation Permission Code(s); reads the Activation status from the device; downloads any flow data not previously downloaded; downloads any schedule that is active on the device, or uploads new schedule; and depending on the Activation status, the U-App prompts the user to either: (1) if the U-Device is new (no authorizations), it requests the required initial information discussed herein to open free manual scheduling; or (2) if initial authorization has been done, suggests advancing to higher authorization(s).

Regarding data collected from U-Device, the downloaded data will be sent to the inventor's cloud when the internet is available to the user's device that executes the U-APP. This may not be a real time process. If the user has authorization to use a specific set of data, the user can access the data through the dashboard of the present invention. The present invention software application will analyze this data for anomalies and use it as a sales tool to upgrade to additional flow authorizations.

The irrigation scheduling can be done for: 24/7; multiple events a day; or a specific duration or water volume (gallons or liters).

Regarding the U-Device Function Authorizations there is a Built in Authorization such that the manual on/off is pre-authorized so it is free and enabled during production. Optionally, this functionality could be included in the Manual Scheduling Authorization.

Next, there could be a Manual Scheduling Authorization. This could be a free option to entice the user to register so the inventors know the customer for further contact. The U-Device can be scheduled for a set duration when it is turned on. It will be turned off at the end of the duration.

Next, there could be a Flow Data Authorization. This is for a one time or recuring fee. The user will get to see the data (that is downloaded by a BT device) on our dashboard. Lumo could then send the usual notices to the user.

Next, there could be a long-term Scheduling Authorization. This could be activated for a fee or no fee. The user will be able to schedule the valve on the dashboard for days or weeks and download it to the device through a BT device.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a simplified schematic representation of the present invention illustrating the electronic fluid control device;

FIG. 2 is a simplified schematic representation of the present invention illustrating the electronic fluid control device of FIG. 1 now in communication with a mobile device and a server;

FIG. 3 is a flow chart of the method of the present invention illustrating a tiered activation of a first additional feature for the electronic fluid control device of FIG. 1;

FIG. 4 is another flow chart of the method of the present invention illustrating a tiered activation of a second additional feature for the electronic fluid control device of FIG. 1;

FIG. 5A is a simplified schematic of a common installation of the present invention;

FIG. 5B is another embodiment of an installation of the present invention now illustrating a primary and a secondary device being installed in a parallel fluid pipe section; and

FIG. 5C is similar to FIG. 5B where now the secondary device has various physical capabilities removed and is controlled by the primary device.

### DETAILED DESCRIPTION OF EMBODIMENTS OF THE INVENTION

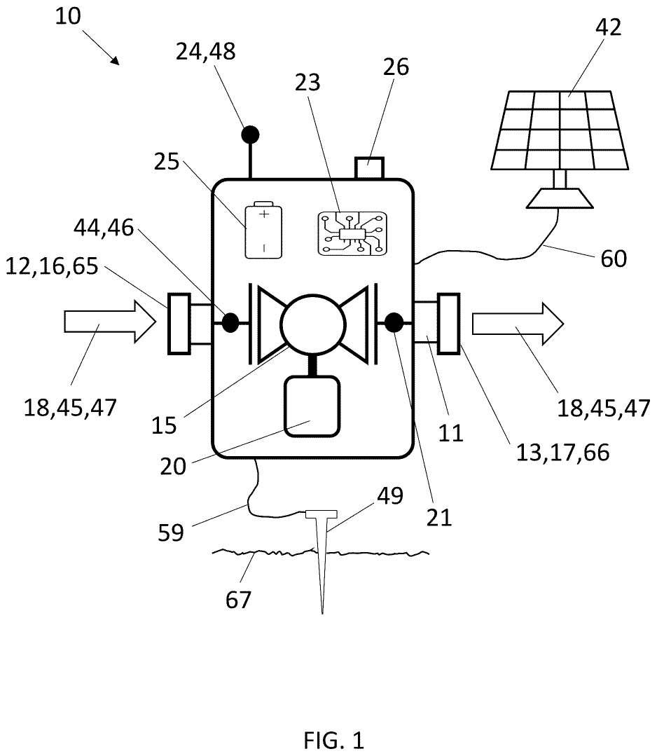

Referring to FIG. 1, the present invention generally relates to an upgradeable electronic fluid control device 10 configured to control a fluid flow 18 through a fluid line while permitting selective activation of additional features through server-authorized provisioning, without requiring physical modification or physical upgrade of the installed device. In an embodiment, the electronic fluid control device 10 includes a fluid pipe section 11 defining a fluid inlet 12 oppositely disposed from a fluid outlet 13, where the pipe section 11 is configured to be connected in series to a fluid pipe 14. A fluid valve 15 is coupled in series within the fluid pipe section 11, separating a fluid inlet side 16 from a fluid outlet side 17, and the fluid valve 15 controls the fluid flow 18 through the pipe section 11. In the illustrated embodiment, an electric motor or solenoid 20 is mechanically connected to the fluid valve 15 and is controllably driven to change the state of the valve 15 between various positions such as open, closed or partly open, thereby modulating or stopping flow through the device 10.

To provide sensing and closed-loop or monitored operation, the electronic fluid control device 10 includes a flow rate sensor 21 coupled to the fluid pipe section 11 and configured to monitor a flow rate 22 of the fluid flow within the pipe section 11. The flow sensor can be installed on the inlet or outlet sides but is normally installed on the inlet side. Common flow rate sensors used in fluid control systems generally fall into a few well-established categories. Differential-pressure flow sensing (e.g., across an orifice plate, venturi, or pitot arrangement) infers flow from a measured pressure drop and is widely used where ruggedness and cost matter. Turbine and paddlewheel meters generate pulses proportional to flow as a rotor spins in the stream, making them common in irrigation and industrial liquid lines. Electromagnetic (“mag”) flowmeters measure voltage induced as conductive fluid moves through a magnetic field, offering good accuracy with no moving parts but requiring electrically conductive fluids. Ultrasonic flowmeters (transit-time or Doppler) can measure flow with clamp-on or in-line configurations, often minimizing pressure loss and mechanical wear. Finally, thermal mass and Coriolis meters are used where mass flow (and sometimes density) is important-thermal more common for gases, Coriolis highly accurate but typically higher cost and pressure-drop. The present invention could use any of the flow sensors described herein.

The flow rate sensor 21 generates one or more sensor signals representative of flow conditions (e.g., instantaneous flow rate, accumulated volume, or a time series of flow), which are provided to a control device processor 23. The control device processor 23 is operatively connected to the electric motor or solenoid 20 and the flow rate sensor 21 and may be implemented using one or more microcontrollers, processors, or other logic devices. The processor 23 can execute instructions stored in memory (e.g., nonvolatile memory and/or volatile memory) to implement control functions, feature gating, and device communications, including maintaining a device identifier, feature states, and activation status information.

The electronic fluid control device 10 includes a control device near-field and/or short-range communication transmitter and receiver 24 coupled to the control device processor 23. The transmitter/receiver 24 supports near-field communication and/or short-range communication 32 with an external electronic mobile device 30, enabling device provisioning, data exchange, and feature activation while a user 35 is present at or near the installed device 10. To be near the device 10, the user would have to be in either near-field communication range or short-range communication range. Near-field communication may be implemented using NFC hardware and protocols, and short-range communication may be implemented, for example, using Bluetooth or other local wireless protocols. The local communication link 32 is used to exchange information such as a device identifier, activation status data, feature state information, and, when authorized, configuration data such as schedules and time synchronization information.

To power the device 10, an electric battery 25 is electrically connected to the electric motor or solenoid 20, the flow rate sensor 21, the control device processor 23, and the communication transmitter/receiver 24. In certain embodiments, the electric battery 25 may be electrically connected by a wired connection 60 to a solar powered charging device 42 to extend operational life and reduce maintenance, particularly in remote agricultural environments.

The device 10 may also include an inlet side connector 65 and an outlet side connector 66 such that the device can easily be installed, removed or replaced with a different device 10 during operation. The connectors drastically improve serviceability of the device 10.

In some embodiments, the processor 23 may enter a low-power or no-power sleep mode 56 and selectively transition to a wake mode 57 to conserve energy when active control or communications are not required. In this embodiment directed to power management and user-initiated communication windows, a manually activated wake button 26 is attached to the electronic fluid control device 10 and is in electrical communication with the control device processor 23. The wake button 26 allows the user 35 to transition the processor 23 from a sleep mode 56 into a wake mode 57. During the wake mode 57, the device 10 enables communication via the transmitter/receiver 24 and performs provisioning and/or data exchange operations including initial user registration and the like. The processor 23 may be configured to return to the sleep mode 56 after a predetermined time 58 has elapsed, thereby limiting power consumption and restricting the exposure window for local wireless interactions. In related embodiments, the wake input can be implemented as any “wake input” capable of transitioning the controller from a sleep state to an awake state, including but not limited to the button 26, an NFC field detection event, a Bluetooth advertising trigger, or other suitable wake sources.

A core aspect of the invention is that the electronic fluid control device 10 is manufactured and installed with hardware capable of supporting multiple operational feature sets, but the availability of those feature sets is selectively controlled by capability levels. In the embodiment described in the independent claims, the electronic fluid control device 10 has a first level capability 28 that is available to a user 35 operating the system, while at least one additional feature 36 is disabled in that first level capability 28. The disabled additional feature 36 may include, by way of example, certain automation modes, advanced scheduling, flow data access, dashboard reporting, OTA operations, or other enhanced functions described herein. A second level capability 38 may be made available to enable the at least one additional feature 36, and in some embodiments a third level capability 51 may further enable at least one second additional feature 52. Notably, the enabling of these additional features is performed without any physical change and/or physical upgrade to the electronic fluid control device 10, thereby allowing a customer to begin with basic functionality and later “upgrade” through authorization and provisioning. As can be understood to those skilled in the art, a multitude of additional features may be selectively activated without any change to the electronic fluid control device 10.

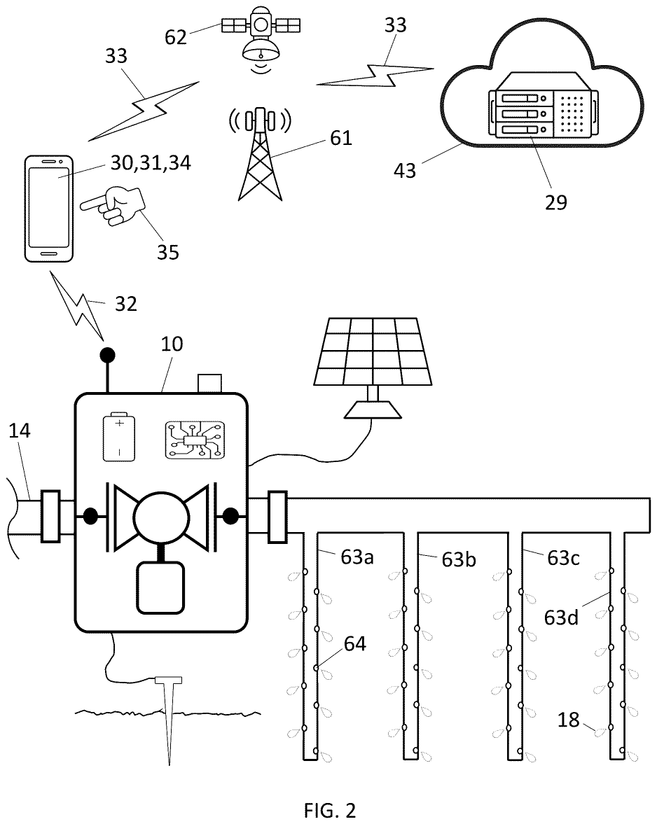

As best seen in FIG. 2, the invention may include a remotely disposed distant server 29, which may be cloud-based 43, and which is disposed remotely relative to the electronic fluid control device 10 and accessible through transmission towers 61 or satellite communication technology 62. The distant server 29 cooperates with the electronic mobile device 30 and a software application 34 executed on the electronic mobile device 30 to implement an authorization workflow. The electronic mobile device 30 may be any suitable smart device such as a smart phone, smartwatch, tablet, laptop computer, or mobile computer, and includes an electronic mobile device near-field and/or short-range communication transmitter and receiver 31 for establishing the local communication link 32 with the electronic fluid control device 10. The electronic mobile device 30 is further configured to establish a long-range communication link 33 (e.g., via cellular, Wi-Fi, or another wide-area network connection) with the distant server 29 to transmit requests and receive responses. The software application 34 (e.g., “U-App”) can guide the user through installation, registration, provisioning, and upgrading of device capabilities.

The electronic fluid control device 10 is connected to a variety of flow paths that are then used to water a variety of crops. FIG. 2 shows just a simplified representation where the main fluid pipe 14 then branches out into individual water pipes 63a, 63b, 63c and 63d such that various crops could be watered through watering holes 64. It is understood by those skilled in the art that this simplified schematic is just one possible embodiment from a limitless number of embodiments that are possible consistent with the teaching of the present invention.

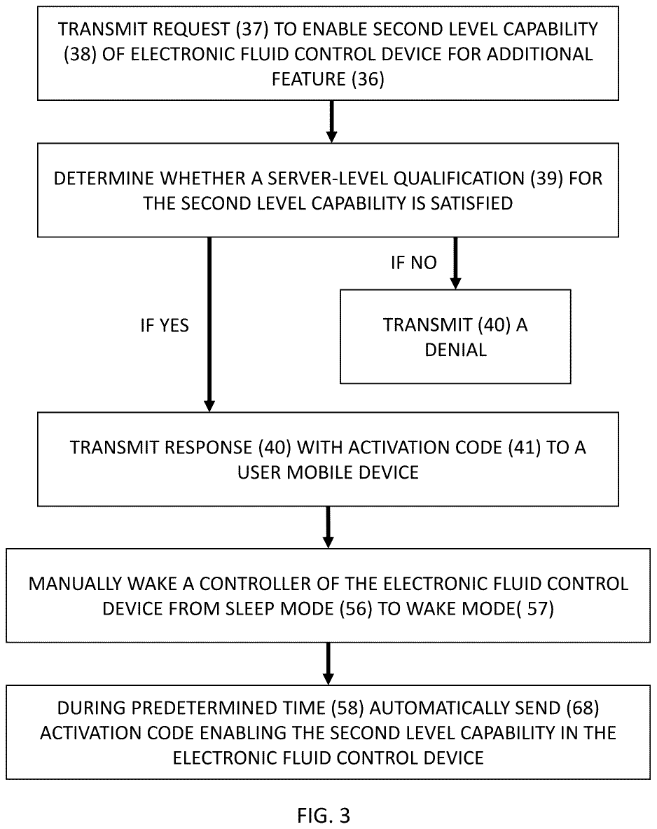

In operation and seen in FIG. 3, the user 35 may initiate a first request 37 from the electronic mobile device 30 to the distant server 29 via the long-range communication 33 for the second level capability 38, where the second level capability 38 enables the at least one additional feature 36 of the electronic fluid control device 10. The distant server 29 evaluates whether the first request 37 can be granted based upon a server level qualification 39. The server level qualification 39 may include, by way of example, one or more informational or financial conditions, such as device ownership, installation location, agreement acceptance, subscription or one-time payment status, user authorization or role, device registration status, or other criteria. The distant server 29 automatically sends a first request response 40 to the electronic mobile device 30 via the long-range communication 33, either granting or denying the first request 37. If the first request is granted, the first request response 40 includes an activation code 41 that enables the second level capability 38. The activation code 41 may be structured to be specific to a particular device identifier and feature authorization and can optionally include access authorization rules indicating whether certain users or all users may access the enabled features.

After receiving the activation code 41, the user 35 manually presses the wake button 26 to wake the control device processor 23 from the sleep mode 56 into the wake mode 57 for the predetermined time 58. During this wake mode 57, the software application 34 causes the electronic mobile device 30 to automatically send 68 the activation code 41 to the electronic fluid control device 10 via the near-field and/or short-range communication 32. The electronic fluid control device 10 receives the activation code 41 via the transmitter/receiver 24 and validates the activation code and, responsive to validation, enables the second level capability at the electronic fluid control device 10 by updating a stored feature state. This validation may include checking that the activation code corresponds to the device identifier, corresponds to the requested capability level, is authentic, and/or satisfies any timing, access, or integrity requirements. Once enabled, the second level capability 38 makes the previously disabled additional feature 36 available for use.

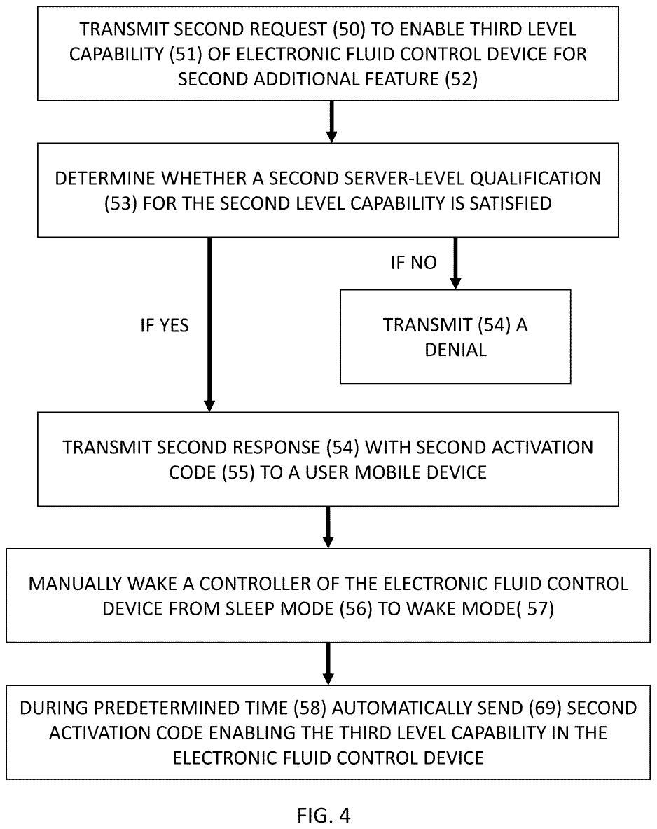

The invention further contemplates multi-tier upgrades beyond the second level capability. In a further embodiment as seen in FIG. 4, the user 35 may transmit a second request 50 from the electronic mobile device 30 to the distant server 29 via the long-range communication 33 for a third level capability 51, where the third level capability 51 enables at least one second additional feature 52. The distant server 29 evaluates whether the request can be granted based upon a second server level qualification 53, which may include additional requirements beyond those of server level qualification 39. The distant server 29 then sends a second request response 54 to the electronic mobile device 30, either granting or denying the request. If granted, the second request response 54 includes a second activation code 55 enabling the third level capability 51. The user 35 again presses the wake button 26 to provide a wake mode 57 window 58, and the electronic mobile device 30 automatically sends 69 the second activation code 55 to the electronic fluid control device 10 via near-field and/or short-range communication 32, thereby enabling the additional features associated with the third level capability 51 without physical change to the device.

In certain embodiments, the electronic fluid control device 10 can include additional sensing components, either as part of the baseline configuration or as capabilities that are activated or made accessible through the tiering mechanism. For example, the electronic fluid control device 10 may include a temperature sensor 44 connected to the fluid pipe section 11 and configured to monitor a temperature 45 of the fluid flow within the pipe section 11.

Additionally or alternatively, the device 10 may include a pressure sensor 46 connected to the fluid pipe section 11 and configured to monitor a pressure 47 of the fluid flow within the pipe section 11. In one embodiment, the pressure sensor 46 is disposed on the fluid outlet side 17 of the fluid valve 15 and no pressure sensor is disposed on the fluid inlet side 16 of the fluid valve 15, enabling, for example, characterization of downstream pressure conditions. In another embodiment, the pressure sensor 46 is disposed on the fluid inlet side 16 and no pressure sensor is disposed on the fluid outlet side 17, enabling, for example, characterization of upstream supply pressure.

The device 10 may further include an environmental temperature sensor 48 connected to the electronic fluid control device 10 and in electrical communication with the control device processor 23 to support environmental compensation, freeze risk assessment, or other analytics.

The device 10 may also include a remotely disposed moisture sensor 49 having a wired electrical connection 59 to the control device processor 23, where the remotely disposed moisture sensor 49 is configured to be physically disposed in a ground 67 nearby the electronic fluid control device 10, thereby permitting soil moisture measurements to be associated with irrigation control, diagnostics, or user-facing reporting.

In an apparatus embodiment, the electronic fluid control device 10 may be understood as including a controller (e.g., the processor 23) coupled to a memory storing at least a device identifier and instructions for implementing multiple capability levels, where a second level capability is unavailable absent an activation code. The device includes a wake input (e.g., wake button 26) and a communication interface (e.g., transmitter/receiver 24) configured for short-range communication with a user device 30. The instructions, when executed by the controller, cause the controller to receive the activation code while awake, validate the activation code, and, responsive to validating the activation code, enable the second level capability at the device 10.

In a system embodiment, the server 29, user device 30, and electronic fluid control device 10 cooperate such that the server 29 receives a request including the device identifier, evaluates a server-level qualification, and transmits an activation code to the user device 30, which provisions the electronic fluid control device 10 via the short-range interface 32, after which the device validates the activation code and updates a feature state to enable the second level capability.

In a computer-readable medium embodiment, instructions stored on a non-transitory computer-readable medium cause the user device 30 to receive a user selection of a capability level, transmit a request to the server 29 including the device identifier, receive an activation code upon satisfaction of the server-level qualification, and transmit the activation code to the electronic fluid control device 10 via the short-range communication interface to cause the device to enable the second level capability.

In use, the tiered activation configuration allows the electronic fluid control device 10 to be installed and operated initially with a first level capability 28 (e.g., basic manual on/off control) while deferring advanced functionality until such time as the user 35 elects to unlock additional features. The local communication arrangement 32 (near-field and/or short-range) and wake-window behavior (sleep mode 56, wake mode 57, predetermined time 58) provide a practical and energy-efficient approach suited for agricultural field environments. The architecture also supports staged adoption: a user 35 may begin with baseline capabilities and later unlock higher tiers (second level capability 38, third level capability 51) through server evaluation (server level qualification 39, second server level qualification 53) and issuance of activation codes (41, 55) delivered through the application 34 on the mobile device 30. Accordingly, the present invention provides a valve controller and associated provisioning system that grows with the user while maintaining a consistent installed hardware platform.

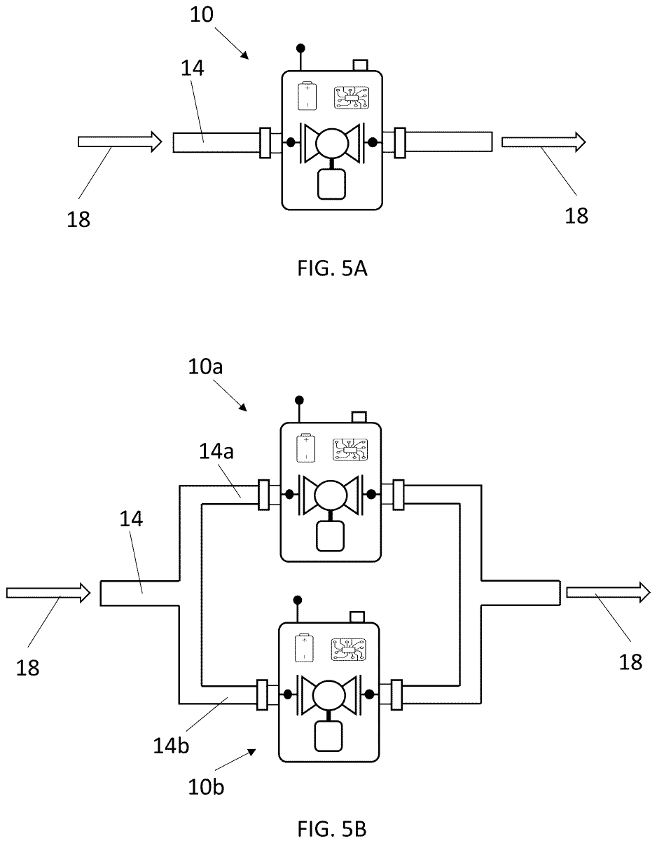

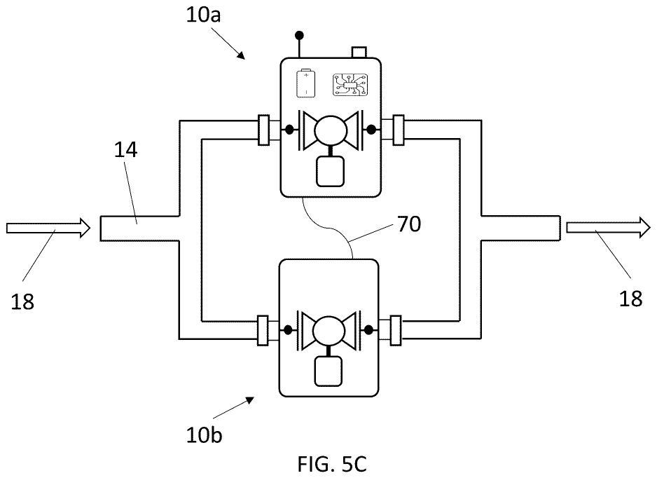

The embodiment shown in FIG. 5A has the electronic fluid control device 10 connected in series with fluid pipe 14. This is a more common installation where the electronic fluid control device 10 controls the entirety of the flow through the fluid pipe 14.

The embodiment shown in FIG. 5B is a variation of FIG. 5A where now there are two devices, a primary device 10a and a secondary (i.e., subordinate) device 10b. As is illustrated, the fluid pipe splits into two parallel sections 14a and 14b that each have the device 10a and 10b of the present invention connected in series to its respective parallel pipe section. This embodiment can be used in situations when a valve of a certain size is not sufficient for the intended flow rate but using a larger size valve is an overkill. This can also be used in situations where there are space limitations that prevent the installation of a larger valve, but where an additional valve can be put in parallel with the primary valve to accommodate the additional flow/duty. This can also be used in situations where redundancy is important, such as with fire control systems or the like.

In the embodiment of FIG. 5B, the electronic fluid control devices 10a and 10b can wirelessly communicate with one another. This usually requires an additional controller, power source, etc. which makes it expensive and complicated. The embodiment shown in FIG. 5C helps alleviate this issue, as the secondary device 10b does not need the battery, control device processor or wireless communication ability. Rather, a hardwire connection 70 can be used connecting the two devices. The hardwire connection can be between auxiliary ports of the devices that are configured to connect the two devices to each other. When this hardwire connection 70 is made, the secondary device will get powered by the primary device and the primary controls the valve opening and closing. Additionally, the flow detected by the secondary device is reported to the primary device and is incorporated in the overall flow data. The only limitation of addition of secondary devices is availability of connection ports on the primary device.

In FIGS. 5B and 5C, when the device 10b senses (i.e., through the hardwire or wireless connection) that it is being used as a secondary valve, it enters a mode that disables any remaining communication capability and any other unnecessary functions of the secondary device to save power. This retrofit can be done by means of removing the battery and the battery leads and connecting a specially configured cable with appropriate terminals. Thus, an installer in the field installing both a primary device 10a and a secondary device 10b can initially use two standard primary devices 10a and then retrofit one of the primary devices to become the secondary device. Optionally, the secondary device's unused parts can be recouped by removing the battery, wireless communication devices and ECUs which can later be used in building additional primary devices. Once again, this is cost savings that can be realized in the field by the installer of the present invention.

It will be understood by those skilled in the art that any number (n) of additional secondary devices (i.e., 10c, 10d, 10e . . . 10n) can be used consistently with the teaching of the present invention as this teaching is not limited to the use of just one secondary device 10b.

In another embodiment, the present invention provides a method of enabling an additional operational capability in an electronic fluid control device that is defined by a minimal set of hardware-centric interactions at the device itself, independent of how an activation token is generated, delivered, or authorized upstream. In this embodiment, the electronic fluid control device includes dormant hardware capable of supporting an additional operational capability that is disabled during initial operation. Feature enablement is performed by transitioning the electronic fluid control device from a low-power sleep state to an awake state through manual actuation of a wake input, thereby establishing a limited wake window during which local provisioning is permitted. While a user device is physically proximate to the electronic fluid control device, an activation token associated with the device is transmitted via a short-range communication interface and locally validated by the electronic fluid control device using a stored device identifier. Upon successful validation, the electronic fluid control device persistently updates an internal capability state to enable the additional operational capability without any physical modification to the electronic fluid control device. Unlike other embodiments described herein, this embodiment does not require, recite, or depend upon server communication, cloud infrastructure, subscription management, payment processing, or multi-tier authorization logic, and instead defines a foundational activation mechanism centered on physical presence, wake-window constraints, and device-resident validation logic.

In a further embodiment, the present invention contemplates a method of enabling an additional operational capability in an electronic fluid control device that does not require communication with, or authorization from, a remotely disposed server at the time of activation. In this embodiment, an activation token associated with a specific electronic fluid control device is generated independently of any remote server communication and may be pre-generated, locally generated, or otherwise provided to a user device without invoking cloud-based authorization, subscription validation, or server-level qualification. The electronic fluid control device is initially operated in a configuration in which one or more operational capabilities are disabled despite the corresponding hardware being physically present within the device. Upon manual actuation of a wake input on the electronic fluid control device, the device transitions from a low-power sleep state to an awake state for a limited wake window. During this wake window, and while a user device is physically proximate to the electronic fluid control device, the activation token is transmitted to the electronic fluid control device via a near-field or short-range communication interface. The electronic fluid control device locally validates the activation token by confirming correspondence with a stored device identifier and, upon successful validation, persistently updates an internal capability state to enable the additional operational capability without any physical modification to the electronic fluid control device. This embodiment is distinct from server-mediated activation embodiments in that feature enablement is performed entirely through local interaction and device-resident validation logic, while still preserving physical-presence requirements, power-management constraints, and persistent capability control.

An exemplary embodiment of the present invention is an electronic fluid control device, comprising: a pipe section defining an inlet and an outlet; a valve disposed between the inlet and the outlet and configured to control flow through the pipe section; a motor (or solenoid) mechanically coupled to the valve and configured to actuate the valve; a flow sensor configured to sense flow through the pipe section and generate a sensor signal; a controller coupled to the motor and the flow sensor; a memory coupled to the controller and storing (i) a device identifier and (ii) instructions that, when executed by the controller, cause the controller to provide at least a first level capability and a second level capability, the second level capability being unavailable absent an activation code; a power source coupled to the controller; a wake input coupled to the controller and configured to transition the controller from a sleep state to an awake state; and a communication interface configured for short-range communication with a user device; wherein the instructions, when executed, further cause the controller to: receive, via the communication interface while in the awake state, the activation code from the user device; validate the activation code; and responsive to validating the activation code, enable the second level capability at the electronic fluid control device. The activation code may comprise: (a) a device identifier field; (b) a capability level authorization field; and (c) a validity condition field.

Another exemplary embodiment of the present invention is a system, comprising: an electronic fluid control device that includes a valve configured to control fluid flow, a motor or solenoid configured to actuate the valve, a controller, a memory storing a device identifier and a feature state, and a short-range communication interface; a user device configured to communicate with the electronic fluid control device via the short-range communication interface; and a server configured to communicate with the user device via a network; wherein the server is configured to: receive, from the user device, a request associated with the electronic fluid control device, the request including the device identifier; determine whether a server-level qualification is satisfied for a second level capability of the electronic fluid control device; and responsive to determining that the server-level qualification is satisfied, transmit to the user device an activation code associated with enabling the second level capability; wherein the user device is configured to transmit the activation code to the electronic fluid control device via the short-range communication interface; and wherein the electronic fluid control device is configured to validate the activation code and, responsive to validation, update the feature state to enable the second level capability.

Another exemplary embodiment of the present invention is a non-transitory computer-readable medium storing instructions that, when executed by one or more processors of a user device, cause the user device to: receive, from a user, a selection of a capability level for an electronic fluid control device, the electronic fluid control device having a device identifier and being configured to communicate via a short-range communication interface; transmit, to a server via a network, a request to enable a second level capability at the electronic fluid control device, the request including the device identifier; receive, from the server, an activation code responsive to the server determining that a server-level qualification for the second level capability is satisfied; and transmit the activation code to the electronic fluid control device via the short-range communication interface to cause the electronic fluid control device to enable the second level capability.

Another exemplary embodiment of the present invention is an electronic fluid control device comprising: a valve; a controller; a memory storing a device identifier and a capability state; a wake input; a short-range communication interface; wherein the controller is configured to: remain in a low-power sleep state absent manual activation of the wake input; receive, during a wake window, a device-specific activation token via the short-range communication interface; validate the activation token by confirming a match to the device identifier and a permitted capability level; and persistently update the capability state to enable an additional operational feature without any physical modification to the electronic fluid control device.

Although several embodiments have been described in detail for purposes of illustration, various modifications may be made to each without departing from the scope and spirit of the invention. Accordingly, the invention is not to be limited, except as by the appended claims.

### NUMERALS

10 electronic fluid control device
10a primary device
10b secondary device
11 pipe section
12 inlet
13 outlet
14 fluid pipe
14a first fluid pipe
14b second fluid pipe
fluid valve
16 fluid inlet side (of valve)
17 fluid outlet side (of valve)
18 fluid flow
20 electric motor or solenoid
21 flow rate sensor
22 flow rate
23 control device processor/controller
24 control device near-field/short-range communication transmitter/receiver
25 electric battery
26 wake button (wake input)
28 first level capability
29 distant server
30 electronic mobile device/user device
31 mobile device near-field/short-range communication transmitter/receiver
32 near-field/short-range communication link
33 long-range communication link
34 software application (app)
35 user
36 additional feature (enabled at higher tier)
37 first request
38 second level capability
39 server level qualification
40 first request response
41 activation code
42 solar powered charging device
43 cloud-based server environment (cloud)
44 temperature sensor (fluid)
45 temperature (fluid temperature)
46 pressure sensor
47 pressure (fluid pressure)
48 environmental temperature sensor
49 remotely disposed moisture sensor
50 second request
51 third level capability
52 second additional feature
53 second server level qualification
54 second request response
55 second activation code
56 sleep mode
57 wake mode
58 predetermined time (wake window duration)
59 wired electrical connection
60 wired electrical connection
61 transmission tower
62 communication satellite in space orbit
63 watering pipes
64 watering holes
65 inlet side connector
66 outlet side connector
67 ground
68 sending first activation code
69 sending second activation code
70 hardwire connection between devices

What is claimed is:

1. A method of activating additional features within an electronic fluid control device, the method comprising the steps of:
a) providing the electronic fluid control device which comprises:
i) a fluid pipe section including a fluid inlet and a fluid outlet configured to be connectable in series to a fluid pipe;
ii) a fluid valve coupled in series within the fluid pipe section separating a fluid inlet side from a fluid outlet side, wherein the fluid inlet side corresponds to the fluid inlet of the fluid pipe section and the fluid outlet side corresponds to the fluid outlet of the fluid pipe section, the fluid valve controlling a fluid flow through the fluid pipe section;
iii) an electric motor or solenoid mechanically connected to the fluid valve;
iv) a flow rate sensor coupled to the fluid pipe section monitoring a flow rate of the fluid flow within the fluid pipe section;
v) a control device processor controllably connected to the electric motor or solenoid and the flow rate sensor;
vi) a control device near-field and/or short-range communication transmitter and receiver coupled to the control device processor;
vii) an electric battery configured to power the electronic fluid control device and electrically connected to the electric motor or solenoid, the flow rate sensor, the control device processor and the control device near-field and/or short-range communication transmitter and receiver; and
viii) a manually activated wake button attached to the electronic fluid control device and in electrical communication with the control device processor;
ix) wherein the electronic fluid control device has a first level capability;
b) providing a distant server disposed remotely in comparison to the electronic fluid control device;
c) providing an electronic mobile device having an electronic mobile device near-field and/or short-range communication transmitter and receiver configured to be in a near-field communication and/or a short-range communication with the electronic fluid control device and configured to be in a long-range communication with the distant server;
d) providing a software application configured to be installed and executed on the electronic mobile device;
e) wherein a user operating the software application on electronic mobile device is enabled to utilize the first level capability of the electronic fluid control device, wherein the first level capability has at least one additional feature of the electronic fluid control device disabled;
f) transmitting a first request from the electronic mobile device, initiated by the user, to the distant server via the long-range communication for a second level capability, where the second level capability enables the at least one additional feature of the electronic fluid control device;
g) evaluating, by the distant server, whether the first request can be granted based upon a server level qualification;
h) automatically sending a first request response from the distant server to the electronic mobile device via the long-range communication either granting or denying the first request;
i) if granted, including in the first request response an activation code enabling the second level capability; and
j) manually pressing, by the user, the manually activated wake button of the electronic fluid control device waking the control device processor from a sleep mode into a wake mode, wherein the control device processor is configured to enter the sleep mode from the wake mode after a predetermined time has elapsed;
k) automatically sending the activation code from the electronic mobile device to the electronic fluid control device via the near-field communication and/or short-range communication during the wake mode enabling the at least one additional feature without any physical change and/or physical upgrade to the electronic fluid control device.

2. The method of claim 1, wherein the electric battery is electrically connected to a solar powered charging device.

3. The method of claim 1, wherein the electronic mobile device is a smart phone, a smartwatch, a tablet, a laptop computer or a mobile computer.

4. The method of claim 1, wherein the distant server is cloud-based.

5. The method of claim 1, wherein the electronic fluid control device comprises a temperature sensor connected to the fluid pipe section monitoring a temperature of the fluid flow within the fluid pipe section.

6. The method of claim 1, wherein the electronic fluid control device comprises a pressure sensor connected to the fluid pipe section monitoring a pressure of the fluid flow within the fluid pipe section.

7. The method of claim 6, wherein the pressure sensor is disposed on the fluid outlet side of the fluid valve and no pressure sensor is disposed on the fluid inlet side of the fluid valve.

8. The method of claim 6, wherein the pressure sensor is disposed on the fluid inlet side of the fluid valve and no pressure sensor is disposed on the fluid outlet side of the fluid valve.

9. The method of claim 1, including an environmental temperature sensor connected to the electronic fluid control device and in electrical communication with the control device processor.

10. The method of claim 1, including a remotely disposed moisture sensor having a wired electrical connection to the control device processor, wherein the remotely disposed moisture sensor is configured to be physically disposed in a ground nearby the electronic fluid control device.

11. The method of claim 1, including the additional steps of:
l) transmitting a second request from the electronic mobile device, initiated by the user, to the distant server via the long-range communication for a third level capability, where the third level capability enables at least one second additional feature of the electronic fluid control device;
m) evaluating, by the distant server, whether the first request can be granted based upon a second server level qualification;
n) automatically sending a second request response from the distant server to the electronic mobile device via the long-range communication either granting or denying the first request;
o) if granted, including in the first request response a second activation code enabling the third level capability; and
p) manually pressing, by the user, the manually activated wake button of the electronic fluid control device waking the control device processor from the sleep mode into the wake mode, wherein the control device processor is configured to enter the sleep mode from the wake mode after the predetermined time has elapsed;
q) automatically sending the activation code from the electronic mobile device to the electronic fluid control device via the near-field communication and/or short-range communication during the wake mode enabling the at least one additional feature without any physical change and/or physical upgrade to the electronic fluid control device.

12. The method of claim 1, including the steps of providing a second electronic fluid control device which comprises:
i) a fluid pipe section including a fluid inlet and a fluid outlet configured to be connectable in series to a second fluid pipe;
ii) a fluid valve 15 coupled in series within the fluid pipe section separating a fluid inlet side 16 from a fluid outlet side 17, wherein the fluid inlet side corresponds to the fluid inlet of the fluid pipe section and the fluid outlet side corresponds to the fluid outlet of the fluid pipe section, the fluid valve controlling a fluid flow 18 through the fluid pipe section;
iii) an electric motor or solenoid 20 mechanically connected to the fluid valve.

13. The method of claim 12, providing a hardwire connection configured to electrically connect the electric motor or solenoid of the second electronic fluid device to the electronic fluid device, wherein the second electronic fluid device is configured to be controlled and operated by the electronic fluid device.

14. The method of claim 13, wherein the second electronic fluid control device does not comprise: a flow rate sensor; a control device processor; a control device near-field and/or short-range communication transmitter and receiver; an electric battery and/or a manually activated wake button.

15. The method of claim 1, wherein the activation code is generated by the distant server to be cryptographically bound to a unique device identifier of the electronic fluid control device, wherein the activation code is rejected by the electronic fluid control device having a different device identifier.

16. The method of claim 15, wherein the activation code encodes authorization for only a specific capability level of the electronic fluid control device, and does not authorize activation of any other capability level.

17. The method of claim 15, wherein the activation code includes a temporal validity condition requiring the activation code to be received and validated by the electronic fluid control device within a predetermined time period.

18. The method of claim 15, wherein the activation code is configured to be consumed by the electronic fluid control device upon successful validation, wherein the activation code cannot be reused to enable the second level capability on the same or a different electronic fluid control device.

19. The method of claim 15, wherein the electronic fluid control device is configured to reject the activation code unless the activation code is received during the wake mode and within the predetermined time following manual activation of the wake input.

20. The method of claim 15, wherein the electronic fluid control device is configured to reject activation codes received via long-range communication and to accept activation codes only via near-field communication or short-range communication while the user is physically present at the electronic fluid control device.

21. A method of enabling an additional operational capability in an electronic fluid control device installed in a fluid line, the method comprising:
a) providing the electronic fluid control device, the electronic fluid control device comprising:
a valve configured to control fluid flow through the fluid line;
a controller operatively coupled to the valve;
a memory storing a device identifier and a capability state;
a wake input configured to transition the controller from a low-power sleep state to an awake state; and
a short-range communication interface;
b) operating the electronic fluid control device in an initial configuration in which the additional operational capability is disabled while corresponding hardware for the additional operational capability is physically present within the electronic fluid control device;
c) receiving, at a user device, an activation token associated with the electronic fluid control device, the activation token being generated based at least in part on the device identifier;
d) manually actuating the wake input to transition the controller into the awake state for a limited wake window;
e) during the wake window, transmitting the activation token from the user device to the electronic fluid control device via the short-range communication interface while the user device is physically proximate to the electronic fluid control device;
f) validating, by the controller, that the activation token corresponds to the device identifier stored in the memory; and
g) responsive to validating the activation token, persistently updating the capability state stored in the memory to enable the additional operational capability without any physical modification to the electronic fluid control device.

22. A method of enabling an additional operational capability in an electronic fluid control device installed in a fluid line, the method comprising:
a) providing the electronic fluid control device, the electronic fluid control device comprising:
a valve configured to control fluid flow through the fluid line;
a controller operatively coupled to the valve;
a memory storing a device identifier and a capability state;
a wake input configured to transition the controller from a low-power sleep state to an awake state; and
a short-range communication interface;
b) operating the electronic fluid control device in an initial configuration in which the additional operational capability is disabled while hardware configured to support the additional operational capability is physically present within the electronic fluid control device;
c) receiving, at a user device, an activation token associated with the electronic fluid control device, the activation token being generated independently of any remote server communication and being based at least in part on the device identifier;
d) manually actuating the wake input to transition the controller from the low-power sleep state to the awake state for a limited wake window;
e) during the limited wake window, transmitting the activation token from the user device to the electronic fluid control device via the short-range communication interface while the user device is physically proximate to the electronic fluid control device;
f) validating, by the controller, that the activation token corresponds to the device identifier stored in the memory; and
g) responsive to validating the activation token, persistently updating the capability state stored in the memory to enable the additional operational capability without any physical modification to the electronic fluid control device.
